(19) United States
(12) Patent Application Publication
(10) Pub. No.: US 2008/0230173 A1
(43) Pub. Date: Sep. 25, 2008

(54) Process for Preparing Front Filter for Plasma Display Panel

(76) Inventors: Kyoo Choong Cho, Cheonan-si Chungcheongnam-do (KR); Chan Hong Park, Seoul (KR); Pyung Guk Park, Seongnam-si Kyungki-do (KR)

Correspondence Address: David A. Einhorn;Anderson Kill & Olick, 1251 Avenue of the Americas, New York, NY, 10020-1182, US

(21) Appl. No.: 10/592,615

(22) PCT Filed: Mar. 31, 2005
(86) PCT No.: PCT/KR2005/000937

§ 371 Date: Sep. 11, 2006

(30) Foreign Application Priority Data
Mar. 31, 2004 (KR) 10-2004-0021951

(51) Int. Cl. B32B 37/02

(52) U.S. Cl. 156/182

(57) ABSTRACT

A plasma display panel (PDP) filter having a high transparency and no exterior defect can be simply prepared by a method comprising the steps of a) laminating a conductive mesh film having a metallic mesh layer formed on a base film, on a transparent glass substrate such that the base film of the conductive mesh film comes in contact with the transparent glass substrate, to obtain laminate A; b) forming a transparent adhesive layer on one surface of an optic film, to obtain laminate B; c) laminating laminate A and laminate B such that the adhesive layer of laminate B comes in contact with the metallic mesh layer of laminate A, to obtain laminate C; and d) heating and pressing laminate C in an autoclave to allow the adhesive layer of laminate B attach to the metallic mesh layer of laminate A.

### FIELD OF THE INVENTION

The present invention relates to a simple and economic method for preparing a front filter for a plasma display panel (PDP) having superior performance characteristics.

### BACKGROUND OF THE INVENTION

PDP is known to be more suitable for a high definition television (HDTV) having an enlarged, flat frame than a cathode ray tube (CRT) or a liquid crystal display (LCD), but has the problems of: releasing harmful electromagnetic interference(EM)/infrared(IR) emissions; high photopic reflection on the surface thereof; and lower color purity than CRT caused by orange light emitted from injected Ne gas. Accordingly, a filter has been applied in front of PDP to solve the above problems.

Such a PDP front filter is designed to comprise a conductive mesh film that is bound to metal mesh pattern at one side of a base film, for shielding against EMI emission. However, the poor light transmittance of such mesh pattern deteriorates filter transparency.

To solve this problem, Japanese Patent Laid-open Publication No. 10-75087 discloses a method for laminating a conductive mesh film on a transparent substrate via a flattening process which comprises filling up the mesh pattern of the conductive mesh film by coating with an adhesive resin such as an epoxy or phenoxy resin and drying it. Further, Japanese Patent Laid-open Publication No. 13-134198 introduces a process for preparing a PDF filter, which comprises placing a thermal adhesive sheet between a conductive mesh film laminated on a transparent glass substrate and an optic film such as an anti-reflection (AR) film or a near infrared (NIR) film; and heating and pressing the resulting laminate inserted in between a SUS derived mirror-finished plate at a temperature ranging from 50 to 200° C. under a pressure of 1 to 10 kg/cm² in a vacuum.

Although this method does not require a separate mesh pattern-flattening process, but there exist the risks of introducing foreign substances and generating exterior defects like dents or scratches during the sheet-pressing process.

### SUMMARY OF THE INVENTION

Accordingly, it is an object of the present invention to provide an improved method for preparing a PDP front filter having a high transparency and no exterior defects, which does not comprise a separate conductive mesh pattern-flattening process.

In accordance with one aspect of the present invention, there is provided a method for preparing a PDP filter which comprises the steps of a) laminating a conductive mesh film having a metallic mesh layer formed on a base film, on a transparent glass substrate such that the base film of the conductive mesh film comes in contact with the transparent glass substrate, to obtain laminate A; b) forming a transparent adhesive layer on one surface of an optic film, to obtain laminate B; c) laminating laminate A and laminate B such that the adhesive layer of laminate B comes in contact with the metallic mesh layer of laminate A, to obtain laminate C; and d) heating and pressing laminate C in an autoclave to allow the adhesive layer of laminate B attach to the metallic mesh layer of laminate A.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic diagram which represents the PDP filters prepared in Examples 1 and 5;

FIGS. 2, 3 and 4: schematic diagrams of the PDP filters prepared in Examples 2, 3, and 4, respectively; and

FIG. 5: a schematic diagram of the PDP filter prepared in Comparative Example 1.

### DETAILED DESCRIPTION OF THE INVENTION

The inventive method is characterized in that an optic film having a transparent adhesive layer on one side thereof is directly attached to a conductive mesh film laminated on a transparent glass substrate in order that the adhesive layer of the optic film comes in contact with the metallic mesh layer of the conductive mesh film, instead of separately performing a mesh pattern-flattening process followed by laminating the optic film using an adhesive, and heat-pressing the resulting laminate by an autoclave process. Therefore, the inventive method can simultaneously perform the optic film-bonding and mesh pattern-flattening processes under a mild condition without using a mirror-finished plate.

According to the present invention, the heat-pressing process of a film laminate is performed by an autoclave process which relies on an air or vapor pressure. As a result, the possible foreign substance infiltration or exterior defect formation is markedly reduced as compared with the case when heat-pressing is undertaken with other pressing means such as mirror-finished plates or a roll.

When the optic film on which an adhesive layer is formed is simply laminated on the mesh pattern, the filter transparency may decrease due to the inclusion of air bubbles inside the pattern. But, the heat-pressing process in an autoclave allows the exclusion of such air bubbles, thereby enhancing the filter transparency.

The autoclave process is performed at a temperature in the range of 40 to 100° C. under a pressure in the range of 1 to 10 kgf/cm², preferably 2 to 7 kgf/cm², for 20 minutes to 2 hours. Upon the completion of the autoclave process, the resulting laminate may be cooled in air, water, or in oil. Considering the production yield, however, water-cooling is more preferred.

Suitable for the transparent adhesive which is used in the present invention is a high weather resistance and heat tolerance compound, and representative examples thereof include an acryl compound, epoxy compound, polyester compound, and a mixture thereof, having a glass transition temperature (Tg) of room temperature (RI) or less and an adhesive strength (at RT, ASTM method) in the range of 1 to 20 N/inch. The adhesive maintains satisfactorily adhesive strength by pressurization at room temperature and shows an improved adhesive strength with heating.

The transparent adhesive may be employed in an amount ranging from 10 to 80% by weight based on the total amount of the adhesive coating composition.

Further, a cross-linking agent may be additionally added to the adhesive coating composition for enhancing the physical properties, e.g., impact strength of the adhesive, in an amount ranging from 1 to 5% by weight of the coating composition, and representative examples thereof include an isocyanate, melanin or epoxy compound. An anti-deterioration agent or adhesive reinforcement agent may also be employed in the adhesive coating composition.

The transparent adhesive and the additional components may be dissolved in an organic solvent to be coated on the substrate. Representative examples of the solvent include toluene, xylene, acetone, methylethylketone (MEK), propylalcohol, isopropylalcohol, methylcellusolve, ethylcellusolve and dimethylformamide (DMF). The coating process of the adhesive composition may be carried out via a common coating technique, e.g., a roll-, die-, comma-, or lip-coating method.

The resulting transparent adhesive layer may be formed to have a thickness ranging from 10 to 100 μm, preferably 15 to 50 μm, for attaining satisfactory adhesive strength and other desired properties (e.g., haze).

In the present invention, the conductive mesh film may be formed by attaching a conductive mesh pattern on a base film such as a transparent thermoplastic film. The conductive mesh may be made of a metallic fiber, a metal-coated fiber, or a patterned metal formed using a photolitho or screen process. The conductive mesh has a width of 5 to 50 μm, a thickness of 1 to 100 μm, and a pitch of 50 to 500 μm. Preferably, the conductive mesh has a thickness of 5 to 50 μm, and a pitch of 100 to 400 μm.

In addition, the optic film used in the present invention may be an NIR cutting/selective optical absorbent film, an anti-reflection (AR) film or a laminate thereof. Also, another optic film selected from the group consisting of an NIR cutting/selective optical absorbent film, an anti-reflection (AR) film and a laminate thereof may be additionally laminated on the other side of the transparent glass surface which is not attached to the conductive mesh film.

The NIR cutting/selective optical absorbent film may be formed by coating an NIR layer composition containing a common NIR cutting pigment and a selective optical absorbent pigment on one surface of a base layer, to form an NIR cutting/selective optical absorbent layer thereon. The NIR film composition comprises suitable amounts of an NIR cutting pigment, selective optical absorbent pigment, transparent binder resin, solvent and optional additives. The coating process of the NIR film composition may be carried out via a common coating technique, e.g., a roll-, die- or spin-coating method.

The AR film may be formed by first coating a scratch-resistant acryl, silicon, melamine or epoxy resins on one surface of a base layer, and then forming a low refractive index layer or forming transparent layers having high and low refractive index alternately. To the high refraction index layer TiO₂, ZrO₂, Nb₂O₅, ITO, SnO₂, In₂O₃ or a mixture thereof, if necessary, together with a transparent resin binder, can be applied; whereas to the low refraction index layer, SiO₂, MgF₂, a fluorine-based compound or a mixture thereof, if necessary, together with a transparent resin binder, can be applied. The coating process of the AR layer composition may be carried out via a vacuum-coating, sputtering, chemical vapor deposition (CVD), roll-coating, dye-coating or mayer bar-coating method.

A representative transparent thermoplastic film which may be used as the base layer of the NIR cutting/selective optical absorbent film, AR film, and the conductive mesh film is made of polyethylene terephthalate (PET), polycarbonate (PC), poly(methyl methacrylate) (PMMA), triacetate cellulose (TAC), polyethersulfone (PES) or a mixture thereof, having a light transmittance of 80% or higher, preferably 90% or higher. The preferable thickness of the base film is in the range of 25 to 250 μm.

According to the present invention, the conductive mesh film may be laminated on the transparent glass substrate such that the base layer of the conductive mesh film comes in contact with the transparent glass substrate. Also, the optic film, e.g., NIR cutting/selective optical absorbent film, AR film or laminate thereof, may be laminated on the conductive mesh film such that the metallic mesh pattern layer of the conductive mesh film comes in contact with the NIR cutting/selective optical absorbent layer, AR layer, or the base layer, of the optic films. The side of the optic film which is not attached to the conductive mesh film may be laminated on the transparent glass substrate such that the adhesive layer of the optic film comes in contact with the other surface of the transparent glass substrate which is not attached to the conductive mesh film, to form a PDP front filter laminate.

In accordance with the method of the present invention, a PDP front filter having a high transparency and no infiltrated foreign substances or exterior defects can be prepared in a simple and economic manner.

The following Examples are intended to further illustrate the present invention without limiting its scope.

### EXAMPLE 1

### Step 1) Preparation of a Coating Solution for NIR Film

300 g of poly(methyl methacrylate) (PMMA) was dissolved in 1000 ml of methylethylketone (MEK) with heating. 1 g of octaphenyl tetraazaporphyrin (disclosed in Korean Patent Laid-open Publication No. 2001-26838) and 15 g of IRG022® (Nippon Chemical pharmaceutical Co.) were added thereto. To the resulting solution, 120 mg of Acridine Orange® (Aldrich Chemical Co.) dissolved in 50 ml of isopropyl alcohol (IPA) was slowly added to obtain a coating solution for NIR film comprising an NIR cutting pigment and a selective optical absorbent pigment.

### Step 2) Preparation of NIR Cutting/Selective Optical Absorbent Film

On one surface of a high transparent polyethylene terephthalate (PET) film of 125 μm thickness, the solution obtained in Step 1 was coated by a comma coating method and dried at 100° C. As a result, an NIR cutting/selective optical absorbent layer (1a) having a thickness of 10 μm was formed to obtain a NIR cutting/selective optical absorbent film (1).

### Step 3) Coating of Transparent Adhesive

25 parts by weight of SK2094® (Soken Co., Japan, Tg: below RT, adhesive strength at RT: 10 N/inch) as an adhesive, 0.01 parts by weight of L-45® (Soken Co.) as a cross-linking agent, 0.005 parts by weight of E-5XM®, and 0.005 parts by weight of A50® (Soken), and 74.98 parts by weight of toluene were mixed together to give an adhesive layer composition. The transparent adhesive layer composition was applied on the NIR cutting/selective optical absorbent layer (1a) of the NIR cutting/selective optical absorbent film (1) obtained in Step 2 by a comma coating method to a thickness of 25 μm, to form an adhesive layer (X).

### Step 4) Filter Lamination

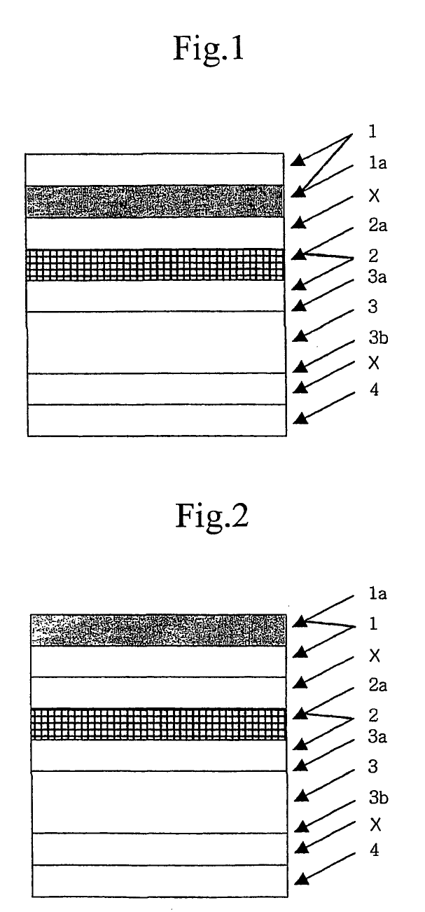

As shown in FIG. 1, a conductive mesh film (2), wherein a copper mesh layer (2a) (line width: 10 μm, line pitch: 300 μm, open area ratio: 93%) was formed on one side of a PET base film and an adhesive layer is formed on the other side of the base film, was laminated on the back face (3a) of a 600×1000×3 mm transparent glass plate (3) such that the adhesive layer came in contact with the transparent glass plate. Then, the NIR cutting/selective optical absorbent film (1) obtained in Step 3 was laminated on the conductive mesh film such that the adhesive layer (X) of the NIR cutting/selective optical absorbent film came in contact with the copper mesh pattern (2a) of the conductive mesh film. To the other side of this laminate, i.e., the front side of the transparent glass substrate (3b), an AR film (4) was laminated using an adhesive layer (X′) to prepare a film laminate.

### Step 5) Autoclave Process

The film laminate obtained in Step 4 was charged into an autoclave and subjected to heating at a temperature of 80° C. and pressing under a pressure of 5 kgf/cm² for 60 minutes. After removing the pressure, the film laminate was cooled for about 30 minutes and a PDD front filter having the laminate structure shown in FIG. 1 was prepared.

### EXAMPLE 2

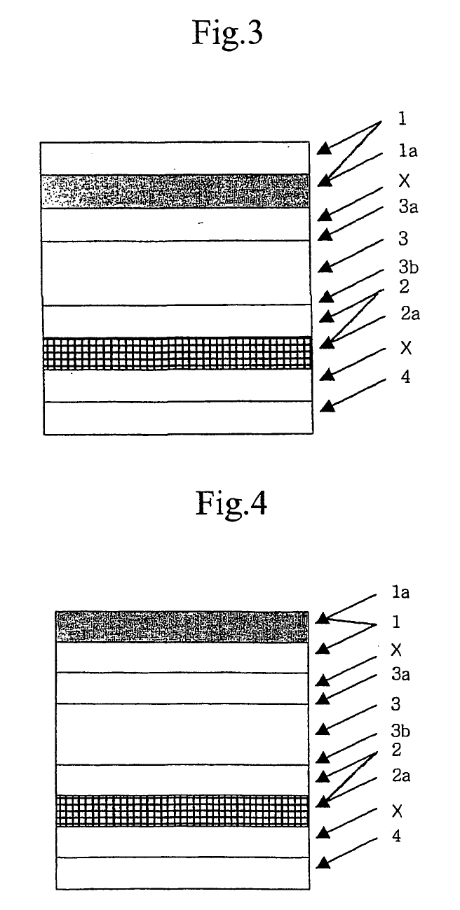

The procedure of Example 1 was repeated except that the adhesive layer (X) was formed on the base film layer of the NIR cutting/selective optical absorbent film, in Step 3; and in Step 4, the NIR cutting/selective optical absorbent film (1) was laminated on the conductive mesh film such that the base film layer of the NIR cutting/selective optical absorbent film came in contact with the copper mesh layer (2a) of the conductive mesh film, to obtain a PDD filter having the laminate structure shown in FIG. 2.

### EXAMPLE 3

The procedure of Example 1 was repeated except that the conductive mesh film (2) was laminated on the front side (3b) of the transparent glass substrate (3); the AR film (4) was further laminated on the metallic mesh layer (2a); and the NIR cutting/selective optical absorbent film (1) was laminated on the back side (3a) of the transparent glass substrate (3) such that the NIR cutting/selective optical absorbent layer (1a) came in contact with the transparent glass substrate (3), in Step 4, to obtain a PDD filter having the laminate structure shown in FIG. 3.

### EXAMPLE 4

The procedure of Example 3 was repeated except that the adhesive layer (X) was formed on the base film layer of the NIR cutting/selective optical absorbent film, in Step 3; and in Step 4, the NIR cutting/selective optical absorbent film (1) was laminated on the transparent glass substrate (3) such that the base film layer of the NIR cutting/selective optical absorbent film came in contact with the transparent glass substrate, to obtain a PDD filter having the laminate structure as shown in FIG. 4.

### EXAMPLE 5

The procedure of Example 1 was repeated except that the film laminate was pressed under a pressure of 2 kgf/cm², in Step 5, to obtain a PDD filter having the laminate structure shown in FIG. 1.

### COMPARATIVE EXAMPLE 1

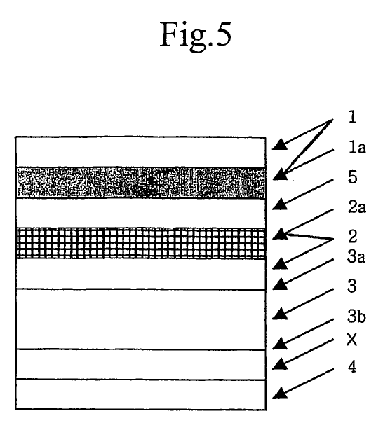

To the back face (3a) of a 600×1000×3 mm transparent glass substrate (3), a conductive mesh film (2) having a copper mesh pattern (line width: 10 μm, line pitch: 300 μm, open area ratio: 93%) (2a) formed on a PET film, an ethylvinylacetate (EVA) sheet (5) having a thickness of 250 μm, and an NIR cutting/selective optical absorbent film (1) having an NIR cutting/selective optical absorbent layer were laminated in order. The substrate (3) was arranged in a position in which it came in contact with the base layer of the conductive mesh film (2). Also, the NIR cutting/selective optical absorbent layer (1a) of the NIR cutting/selective optical absorbent film (1) was positioned to make a contact with the EVA sheet (5). On this resulting laminate, an SUS plate having a thickness of 1 mm was placed. Then, the resulting laminate was transferred to a vacuum presser, ventilated for 30 minutes to maintain a vacuum of 10 Torr and was applied with a pressure of 10 kgf/cm² at 120° C. After 30 minutes, the presser was brought to an ambient pressure and the assembly was cooled for 30 minutes. An AR film (4) was laminated on the front side (3b) of the transparent glass substrate (3) to prepare a PDP front filter (see FIG. 5).

### TEST EXAMPLE

The PDP front filters prepared in Examples 1-5 and in Comparative Example were measured for its haze and for the number of defects. The results are shown in Table 1.

The haze data was acquired with a spectraphotometer using integrating spheres, and the number of defects was measured by an exterior visual inspection under a reflection light and transmission light. The reflection light, installed perpendicularly 1 meter above the filter, was measured from the filter side. The filter was installed with black background. As a reflection light, a normal diffusion fluorescent light having 6500 K color temperature was inserted into the filters and it showed an illumination intensity of approximately 500 Lux 10% at the inspection site. The transmitted light, placed vertically 1 meter below the filter, was measured from the filter side. The filter was installed in front of a white diffusion lighting, which had a release speed of 250 cd/m². The inspector was positioned perpendicular to the inspection side.

TABLE 1

| | Haze (%) | No. of Defects |
|---|---|---|
| Example 1 | 1.2 | 0 |
| Example 2 | 1.5 | 1 |
| Example 3 | 1.2 | 0 |
| Example 4 | 1.5 | 1 |
| Example 5 | 1.5 | 2 |
| Comparative Example | 2.0 | 4 |

As can be seen from Table 1, the PDP filter prepared in accordance with the inventive method comprising the steps of laminating an optic film having a transparent adhesive layer on one side thereof, on a conductive mesh film such that the transparent adhesive layer of the optic film comes in contact with a metallic mesh layer of a conductive mesh film, and heat-pressing the resulting laminate by an autoclave process shows reduced haze and lower number of defects compared to the prior art filter prepared by placing a thermal adhesive sheet between a conductive mesh film and an optic film, followed by heating and pressing the laminate using a mirror-finished plate under a vacuum.

While the invention has been described with respect to the above specific embodiments, it should be recognized that various modifications and changes may be made to the invention by those skilled in the art which also fall within the scope of the invention as defined by the appended claims.

What is claimed is:

1. A method for preparing a plasma display panel (PDP) front filter, which comprises the steps of
a) laminating a conductive mesh film having a metallic mesh layer formed on a base film, on a transparent glass substrate such that the base film of the conductive mesh film comes in contact with the transparent glass substrate, to obtain laminate A;
b) forming a transparent adhesive layer on one surface of a first optic lo film, to obtain laminate B;
c) laminating laminate A and laminate B such that the adhesive layer of laminate B comes in contact with the metallic mesh layer of laminate A, to obtain laminate C; and
d) heating and pressing laminate C in an autoclave to allow the adhesive layer of laminate B attach to the metallic mesh layer of laminate A.

2. The method of claim 1, wherein the transparent adhesive is selected from the group consisting of an acryl compound, an epoxy compound, a polyester compound and a mixture thereof, said transparent adhesive having a glass transition temperature (Tg) of room temperature or less, and an adhesive strength at room temperature in the range of 1 to 20 N/inch.

3. The method of claim 1, wherein the transparent adhesive layer has a thickness in the range of 10 to 100 μm.

4. The method of claim 1, wherein laminate C is heated at a temperature ranging from 40 to 100° C. and pressed under a pressure ranging from 1 to 10 kgf/cm² in an autoclave.

5. The method of claim 1, wherein the first optic film is selected from the group consisting of a near infrared (NIR) cutting/selective optical absorbent film, an anti-reflection (AR) film and a laminate thereof.

6. The method of claim 1, which further comprises the step of laminating a second optic film selected from the group consisting of a near infrared (NIR) cutting/selective optical absorbent film, an anti-reflection (AR) film and a laminate thereof, on the other side of the transparent glass substrate that is not attached to the conductive mesh film.

7. The method of claim 6, wherein the first optic film is the NIR cutting/selective optical absorbent film and the second optic film is the AR film.

8. The method of claim 6, wherein the first optic film is the AR film and the second optic film is the NIR cutting/selective optical absorbent film.

9. The method of claim 6, wherein the first optic film is the AR film and the second optic film is the laminate of the anti-reflection (AR) film and the NIR cutting/selective optical absorbent film.

10. The method of claim 6, wherein the first optic film is the laminate of the anti-reflection (AR) film and the NIR cutting/selective optical absorbent film the AR film, and the second optic film is the laminate of the anti-reflection (AR) film and the NIR cutting/selective optical absorbent film.
